(19) United States
(12) Patent Application Publication
(10) Pub. No.: US 2005/0139085 A1
(43) Pub. Date: Jun. 30, 2005

(54) Kernal Catcher

(76) Inventor: Jonathan J. Clark, Wichita, KS (US)

Correspondence Address: Bradley P. Sylvester, Suite 300, 200 North Broadway, Wichita, KS, 67202, US

(21) Appl. No.: 10/746,827

(22) Filed: Dec. 29, 2003

(51) Int. Cl. A23L 1/18

(52) U.S. Cl. 99/323.5

(57) ABSTRACT

A combination funnel and securing means, for use with a flexible popcorn container, such as a microwave popcorn bag, and which defines a suitable opening to direct popcorn through for consumption. The funnel is inserted into the mouth of the container or bag, with the sides of the bag adjacent to the outer sides of the funnel. A strap means is placed over the container/bag and funnel, securing the strap means to the bag and funnel, fixing all three in position to each other. The strap may also define a reservoir or cavity area, which covers the bottom front end of the funnel, and which is able to receive unpopped popcorn kernels that fall through defined apertures in the bottom front of the funnel.

### BACKGROUND OF THE INVENTION

Prior attempts have been made to create a means whereby popcorn and other snack products can be eaten without having to use your fingers. Popcorn itself generally comprises a food products that contains surface grease that is undesirable for transfer to clothing and other items.

Prior art patents have shown an attempt to cure this problem, but have not been adequately incorporated together to work with a typical popcorn container such as a bag. One prior art patent of significance is U.S. Pat. No. 6,431,415 (Schreiber), which describes a funnel that is capable of being attached to the top of a popcorn container, where the container it self comprises a circular shaped cup. While this particular intervention works well with that type of popcorn container, it does not work with the more common popcorn container in use today, being a popcorn bag that is used in a microwave. Such popcorn bags are prepackaged, have a generally uniform size, and also contain copious amounts of buttery flavored oils. It is this type of food product that most needs some type of guard or protection from oil transference during eating, since these type of popcorn snack bags are often present in the workplace or around family furniture that is not conducive to having such oils transferred to them.

Wherefore, there exists a need for a funnel means that directs popcorn from a popcorn container such as a popcorn bag, and which protects the consumer from popcorn contact with the hands.

Further, it is the purpose of this invention to not only protects the consumer from needing to have hand contact with microwave popcorn, but also supplies a means whereby the unpopped popcorn kernels are separated from the popped popcorn before they make it to the consumer's mouth.

It is a further object and purpose of this invention to provide a means that is reusable over and over again with multiple microwave popcorn bags.

### DESCRIPTION OF THE DRAWINGS

FIG. 1 depicts an exploded view of the bag funnel assembly along with a bag.

FIG. 2 is a perspective view of the bag final assembly, where the funnel portion has been inserted into the bag portion.

FIG. 3 is a perspective view of the bag funnel assembly, in which the funnel portion has been inserted into the bag portion, with the sleeve reservoir positioned around the bag and funnel portion.

FIG. 4 is a side view of the arrangement of the bag funnel assembly, with the position of the funnel, reservoir and bag as shown in FIG. 1.

FIG. 5 is a side view of the arrangement of the bag funnel assembly, with the position of the funnel, reservoir and bag as shown in FIG. 2.

FIG. 6 is a side view of the arrangement of the bag funnel assembly, with the position of the funnel, reservoir and bag as shown in FIG. 3.

FIG. 7 is a side view of the sleeve reservoir.

FIG. 8 is a side view of the funnel.

FIG. 9 is a side view of the funnel shown inserted inside the sleeve reservoir.

FIG. 10 is a perspective view of the funnel, as seen from the front and top side of the funnel.

FIG. 11 is a perspective view of the sleeve reservoir, as seen from the front and top side of said sleeve reservoir.

FIG. 12 is a perspective view of the funnel, as seen from the back and left side of the funnel.

FIG. 13 is a perspective view of the sleeve reservoir, as seen from the back and left side of the reservoir.

FIG. 14 is a perspective view of the funnel, as seen from the front and bottom side of said funnel, where multiple apertures are shown through the front portion of said funnel.

FIG. 15 is a perspective view of the funnel, as seen from the front and bottom side of said funnel, where a single slit is defined in the front portion of the funnel.

FIG. 16 is a perspective view of the sleeve, with a flap shown in an upward position.

FIG. 17 is a perspective view of the sleeve with the flap in a down position, placed over a funnel assembly.

FIG. 18 is a funnel, as seen from the top side, with the sleeve reservoir shown placed immediately adjacent and in front of the funnel, with the sides of the sleeve having an attachment hook on either side.

FIG. 19 is a funnel, as seen from the top side, with the sleeve reservoir shown placed over the funnel with the attachment hooks placed behind the funnel.

FIG. 19 is a view of the funnel, as seen from the back side, with the apertures comprising oval openings.

FIG. 20 is a perspective view of a sleeve and funnel, with the sleeve comprising a band.

FIG. 21 is a perspective view of a funnel with an elastic sleeve fitted around it.

FIG. 22 is a perspective view of the reservoir from the front side, in which the reservoir has an adjustable sleeve.

FIG. 23 is a perspective view of the reservoir from the back side, in which the reservoir has an adjustable sleeve.

FIG. 24 is a perspective view of the funnel, as seen from the rear, depicting oval shaped apertures.

### SUMMARY OF THE INVENTION

This intervention comprises a novel apparatus for use with a prepackaged bag of popcorn, such as the type typically sold in stores for home preparation in the microwave. This invention also is compatible with other popcorn containers, including those bags which receive pre-popped popcorn for individual retail sale.

When preparing prepackaged popcorn at home, and where using a microwave compatible bag, the act of consuming the popcorn without causing the spread of the oils and butter flavorings in an undesired manner is difficult to avoid. The problem of associated oils with the home bagged popcorn is due to the fact that a person eating this popcorn is often in close contact with cloth covered furniture, carpeting, furniture surfaces and clothing, or in the workplace around papers and other items that need to avoid contact with oils. The oils on the popcorn are readily transferred to a consumer's hand when they grab onto the popcorn, and which in turn is often then transferred unintentionally to the surfaces noted above.

Popcorn, due to its high volume and a low mass ratio is generally unsuitable for consumption using utensils. Using bare hands is the common method of transferring popcorn to the consumer's mouth. A common method of popcorn consumption, which attempts to avoid the accumulation of oil products on the consumer's hand, is done by simply tilting the bag or popcorn container, and letting popcorn exit through gravitational force directly into the consumer's mouth. It is similar to the same actions done while attempting to drink a glass of water.

A clear drawback to attempting to pour popcorn directly from the container into the mouth of a consumer is that popcorn does not tend to flow evenly, causing sporadic clumping of the popcorn during a pouring process. This causes popcorn and the oils on its surface, to spill and contact other items. In addition, popcorn that has been popped generally has a certain amount of unpopped kernels mixed in with the popped portion. These unpopped kernels are easily able to mix into the flow of popcorn being poured out of a container, and if they are being directly fed into a person's mouth, increase the risk of choking or other discomfort. Further, unpopped kernels may simply settle to the bottom of the container, and during a pouring procedure, literally move past the lighter popped kernels by sliding under them, and exit the container ahead of the other popcorn.

This present apparatus comprises a modified funnel that has been shaped so as to approximate the mouth opening of a typical popcorn bag. Other sizes and configurations may be used, so as to more closely match the popcorn container it is intended to be used with.

The funnel is a generally rectangular shaped cylindrical funnel that has had approximately one half of the cylindrical sleeve portion removed, so as to create a protruding spout portion. The spout portion provides a platform extending outward from the funnel opening, rather then a tubular exit from the funnel. In this manner, the spout is similar to the lip of a glass or similar container, which allows popcorn exiting the main body of the funnel to avoid clumping that would typically block the opening of the funnel.

It is important that the funnel cover the open mouth portion of the popcorn bag, so as to properly direct all contents of the bag through the defined funnel opening. While the funnel could be placed over a bag opening, it is not securable using the separate reservoir member. It is therefore a preferred embodiment that the funnel be placed inside the mouth opening of the popcorn container, and that the bag opening remained fixed in position to the sides of the final portion, and the reservoir's sleeve portion be slid over the bag and funnel, to secure all three items to each other.

The funnel portion also may exhibit small openings or a slit opening defined on the bottom front side of said funnel, which are able to accommodate unpopped kernels, but which are too small to allow the passage of popcorn through them. The openings and/or slit are able to filter out the heavier unpopped kernels as they move through the funnel portion towards the opening. Unpopped kernels that fall through the holes and/or slit are able to be collected in a separate area, being a reservoir, thus preventing these unwanted unpopped kernels from been consumed with the popped kernels.

A sleeve reservoir defines an interior dimension that allows it to be placed over the bag or popcorn container portion that surrounds the funnel inserted therein. Both the funnel and sleeve reservoir are optimally slightly fluted toward the back opening, so that as the sleeve reservoir moves over the funnel portion, they will eventually reach the point where the sleeve reservoir interior surface is pressed tightly against the exterior sides of the funnel and surrounding bag or popcorn container. In this manner, the sleeve reservoir holds the popcorn bag/container in place around the funnel, and also provides a reservoir collection area for unpopped kernels to move into once they exit through the requisite openings in the funnel. The sleeve reservoir allows the spout and funnel opening full access, with the purpose of this sleeve reservoir being to grip the bag between it and the funnel, and also to provide a means to catch and store unpopped kernels.

The sleeve reservoir may be attached to funnel, using simple friction to hold the sleeve reservoir in place against the funnel body, or the sleeve reservoir may also comprise an attachment means, whereby the sleeve reservoir is held in position and unable to be removed from around the funnel body without releasing the attachment means. An example of attachment means would comprise a series of rearward extending hooks that fit around the back edge of the funnel.

In place on the sleeve reservoir, a simple elastic band may be used, in which the funnel is inserted into the mouth of a bag, so that the bag fits around the outer sides and body of the funnel, with an elastic band then placed around the bag and funnel combination, to hold the bag in position around the funnel.

This apparatus also provides a novel method in which the funnel assembly is able to be used to serve popcorn without requiring physical contact of the consumer with the contents of the popcorn bag. In place of the reservoir, that bag may be held against the funnel through any elastic means that constricts the mouth opening of the bag against the outer surface sides of the funnel. In this situation, unpopped kernels will settle to the bottom of the container and funnel, with the funnel defining a shape that allows these kernels to be collected, when the bag and funnel are tilted for the purposes of pouring the popcorn out.

It is therefore an object of this invention to provide a means whereby common microwave bag popcorn is able to be served and consumed without requiring human contact during the transfer of the popcorn into the consumer's mouth.

It is a further object of this invention to provide a means whereby popcorn may be consumed without having to make physical contact with the popcorn prior to it entering the consumer's mouth, using any flexible container to hold popcorn along with an appropriately sized funnel and restriction means around the bag.

It is a further object of this invention to provide a means to serve popcorn in a manner that avoids undesired spread of oil products, which is a reusable again and again with subsequent bags of popcorn.

It is a further object of this invention to provide a novel method for securing a funnel within a popcorn bag to allow ease of consumption of the popcorn without contact with undesired oil products.

### DETAILED DESCRIPTION OF THE INVENTION

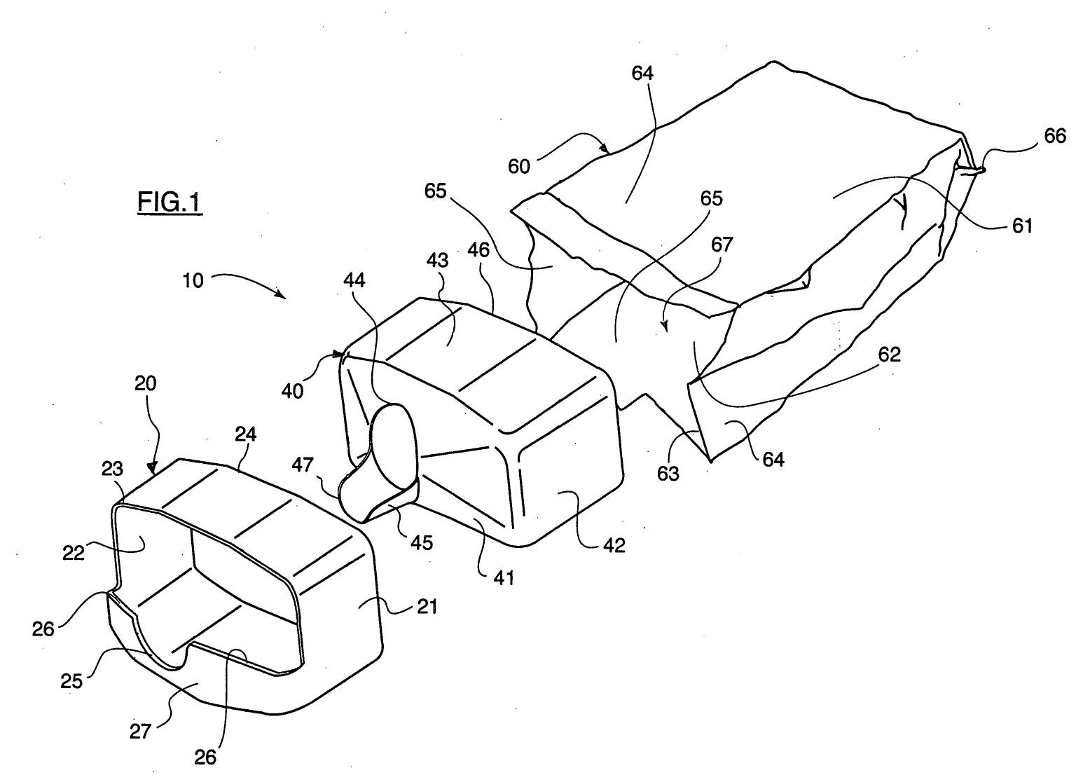

Referring now to FIG. 1, a bag funnel assembly 10 is shown, comprising a funnel 40 and a sleeve means, also referred to as a sleeve reservoir 20. Said funnel 40 and sleeve reservoir 20 are capable of being used with a popcorn container, such as a typical popcorn bag 60, such as the kind used for microwavable type popcorn, so as to direct the flow of popped popcorn out of the bag 60 in a manner whereby the popcorn may be directed to the consumer's mouth, and consumed directly without hand contact with said popcorn.

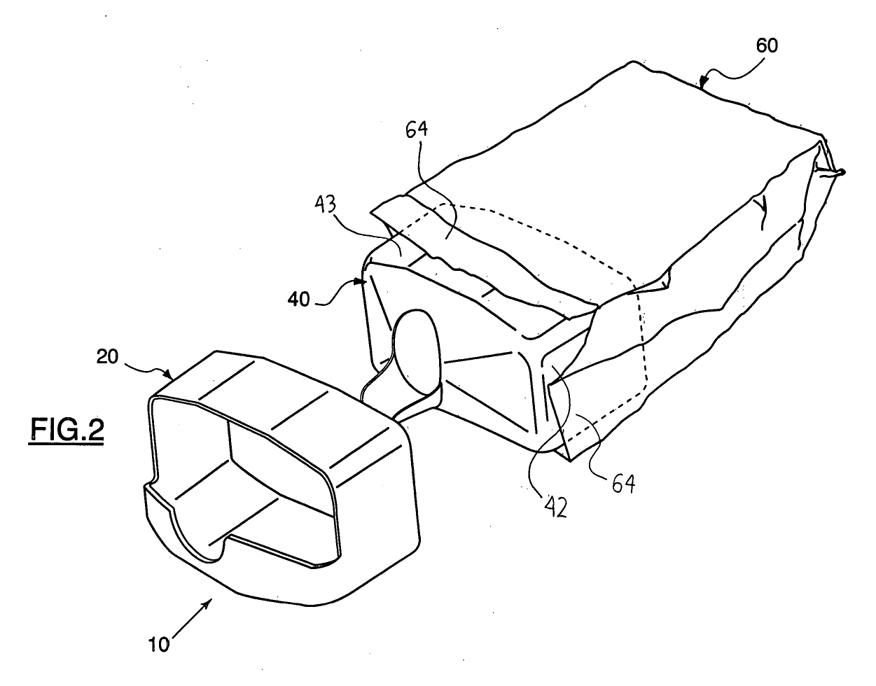

FIG. 2 depicts the insertion of the funnel 40 into the mouth 67 of bag 60. Bag 60 has inner sides 65, which contact the outer sides of the sleeve portion 43, when funnel 40 is inserted into bag 60. The outer sides of the bag, or flaps 64, cover a portion of funnel 40.

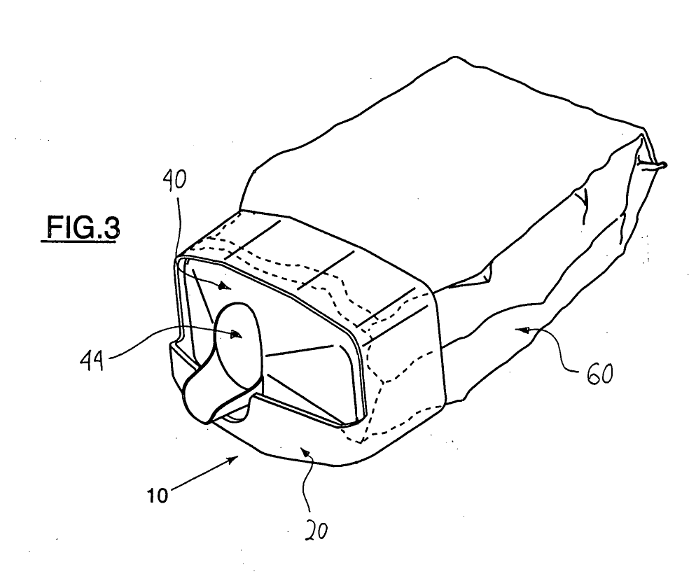

FIG. 3 depicts the Sleeve reservoir 20 having been placed over the funnel 40 bag and flaps 64, so that flaps 64 are situated between the funnel 40 and sleeve 20. The only opening out of the bag 60 comprises opening 44, which allows popcorn to exit the combination of the sleeve 20 funnel 40 and bag 60.

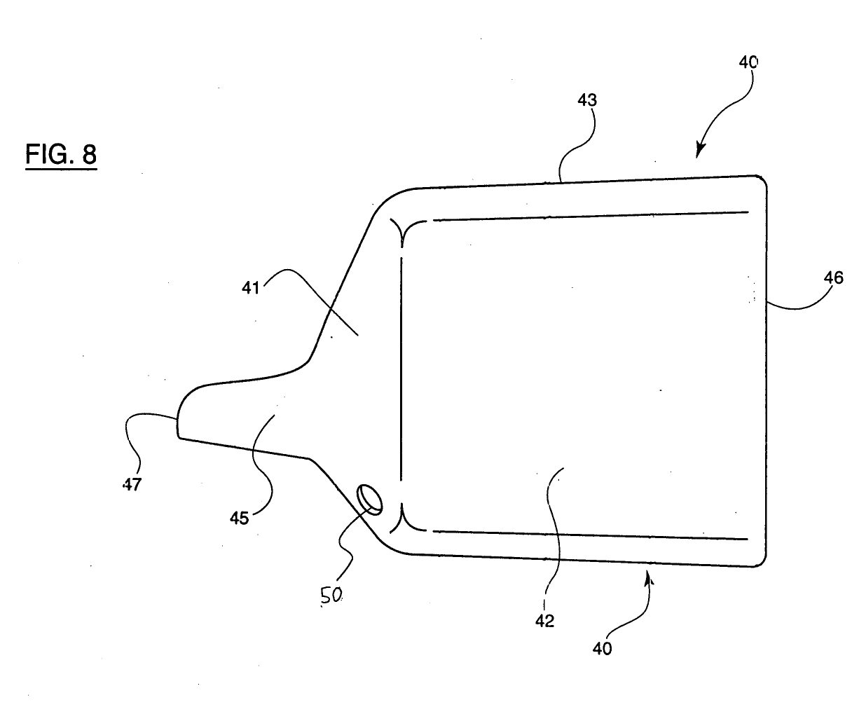

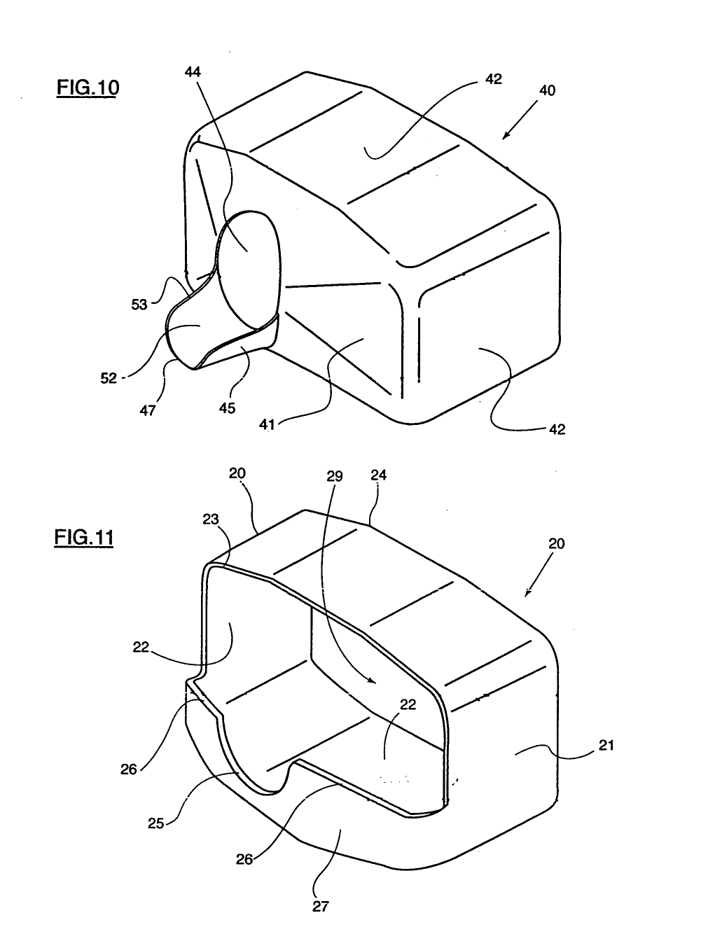

The funnel 40 is shown as an individual item in FIGS. 8, 10, 12, 14, and 15. FIG. 8 depicts the side view configuration of said funnel 20. Referring to said figures, the funnel 20 is defined as a hollowed body that defines a generally rectangular shape, as defined by a pair of vertical outer side surfaces 42, a top horizontal outer surface 43 and a bottom horizontal surface 33. Generally, the outer circumference of said combined surfaces 42, 43 and 33 increases in overall circumference as measured from the front to the back side edge 24.

The funnel 40 typically decreases in overall circumference towards the front side of said funnel 40. As is shown in the above noted figures, the funnel outer front surface 41 is seen as a generally angled front side that defines an opening 44, having a generally circular shape, as defined by the opening edge 36 and spout 45. The bottom portion of the opening 44 is defined by a protruding spout 45, that extends forward of the outer front surface 41, where said spout 45 tapers along a spout edge 53 and terminates forward of said outer front surface 41 by the lip 47. Said spout 45 is intended to provide a channel, whereby popcorn pieces moving through the funnel 40 and exiting through said opening 44, will be directed forward of the main body of the funnel 40 and outer front surface 41 of said funnel 40.

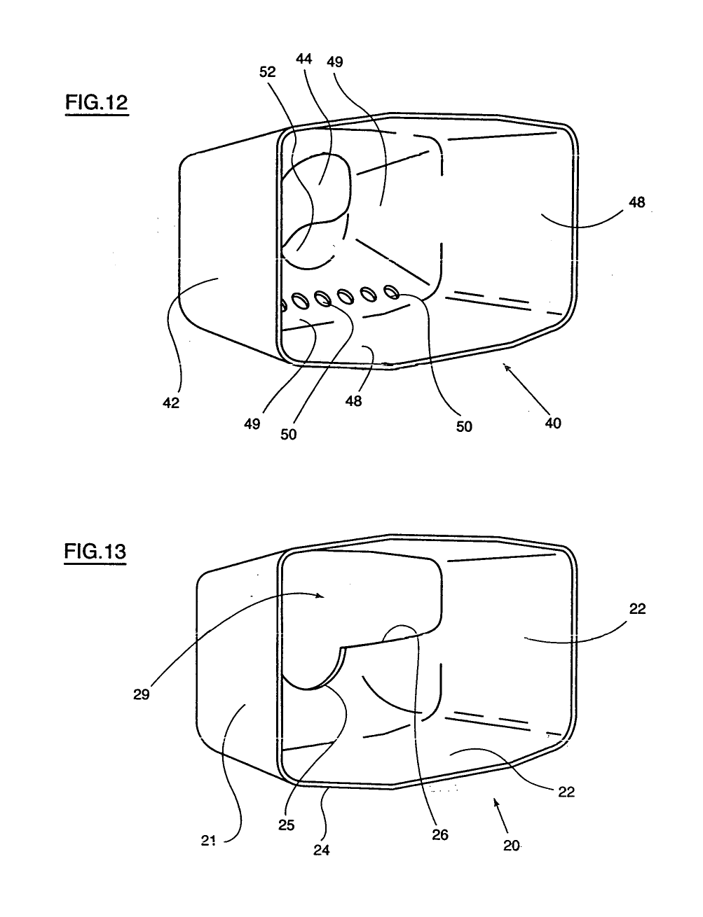

Referring also now specifically to FIG. 12, the interior portion of the funnel 40 is shown, in which the inner side edges 48 and inner funnel edge 49 comprise the interior surfaces of said funnel 40. Popcorn moving into the interior portion of the funnel 40 will be forced to exit through the opening 44, and are directed forward of the main funnel body by moving through the channel defined by the spout top surface 52. The spout 45 allows popcorn to be directed a distance away from the funnel means 40 and any sleeve means 20, so that it can be poured directly into a person's mouth.

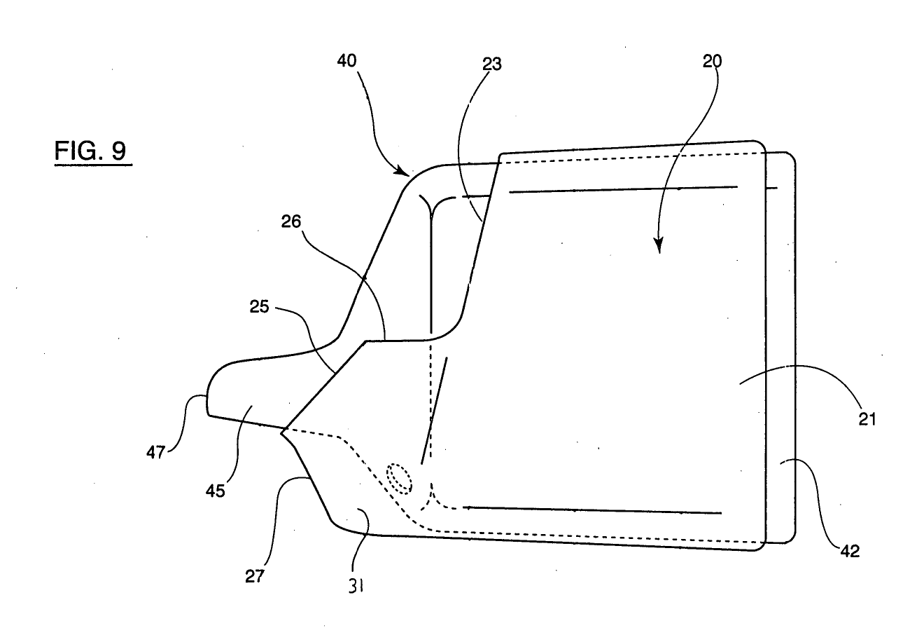

As is also shown in FIG. 12, a series of apertures 50 are defined through the funnel wall along the bottom side of the funnel side 49. These apertures 50 are preferably larger in circumference than the typical unpopped popcorn kernel, which will allow the typical popcorn kernel to move through the apertures 50, but have a diameter insufficient to allow the popped fluffy popcorn from being unable to move through said apertures 50. The apertures 50 function effectively as a strainer to remove the unwanted unpopped popcorn kernels from a mixture of popped popcorn and unpopped kernels, prior to the popcorn moving through the opening 44 to the consumer. The unpopped kernels fall through the apertures 50, into a cavity 31, as noted specifically in FIG. 9.

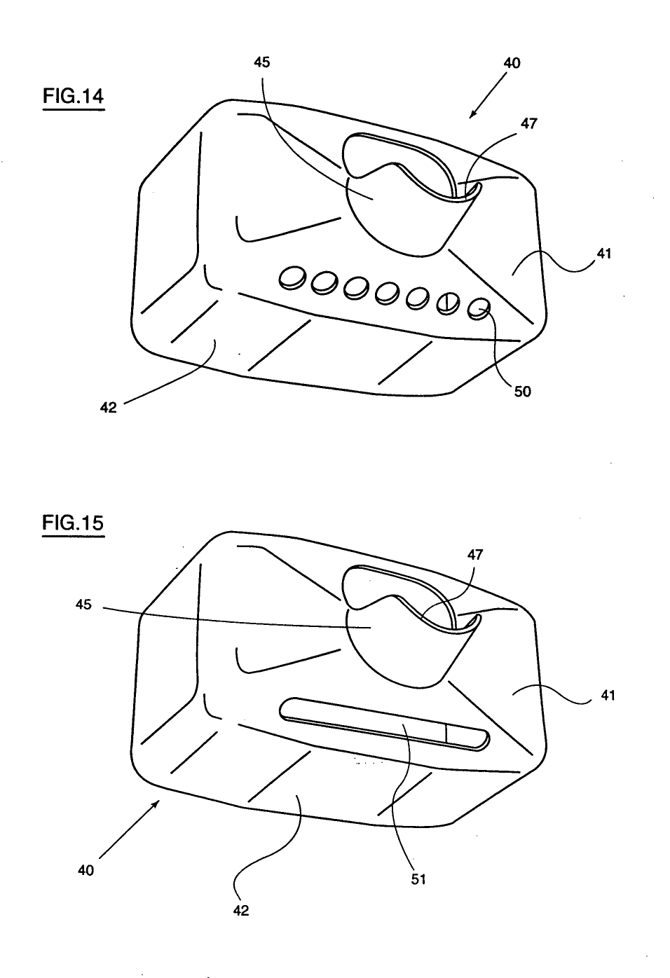

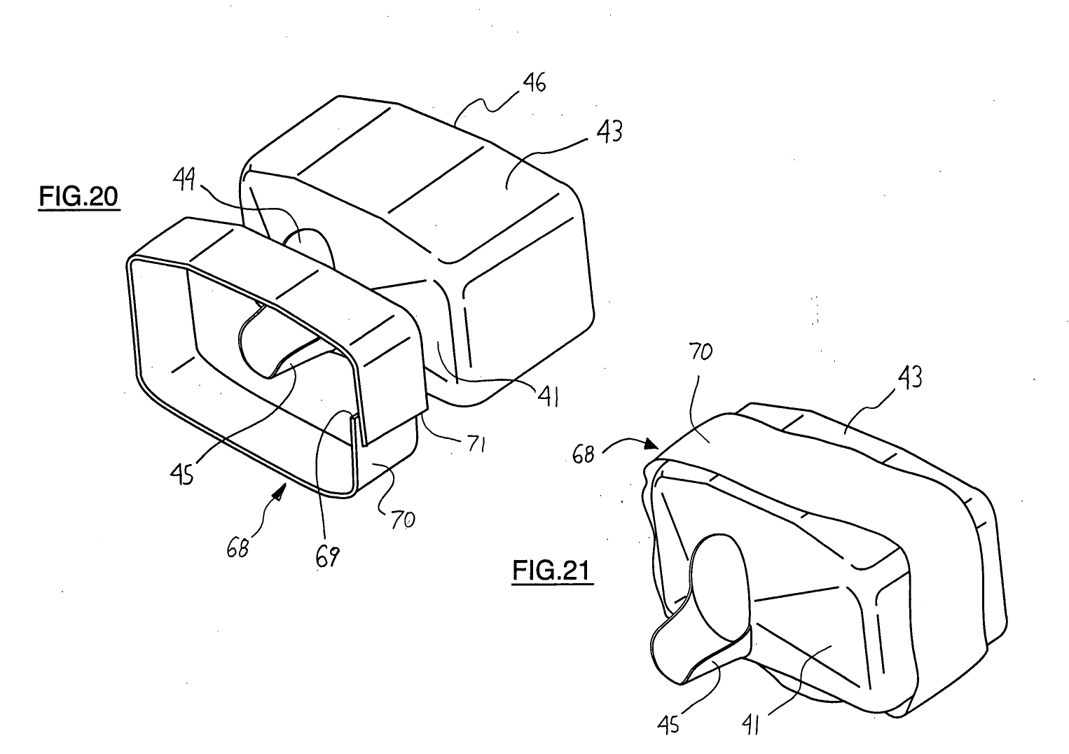

The apertures 50, shown in FIG. 12 and FIG. 14, may have any desired shape and/or configuration, as long as they provide an opening through which unpopped popcorn kernels may move through, and which serve to separate them out from the popped popcorn. Referring also to FIG. 19, the funnel 40 is shown, in which the apertures 50 comprise oval openings. This shape assists in allowing unpopped popcorn kernels to move through said apertures 50, due to the teardrop shape of the unpopped popcorn kernels, which more readily fit through said apertures 50 than if the apertures had a circular shape.

As shown also in FIG. 15, instead of multiple apertures 50, a single slit 51 is shown, as defined as a single opening through the front funnel wall. The width of the slit 51 is sufficient to allow an unpopped popcorn kernel to pass through it, but whose width is insufficient to allow a typical popped popcorn to pass through. In this respect, and the slit 51 functions as a strainer into same manner as the apertures 50 do.

The spout 45 provides a channel by which popcorn moving through the opening 44 is directed forward of the body of the funnel 40. It should be understood that a spout is not required for this invention, but has a function that increases the utility of this invention. Said spout 45 is useful in directing the popcorn that has passed through the opening 44, outward from the sleeve reservoir 20, where a sleeve reservoir 20 is used in conjunction with the funnel 40. While the funnel 40 may be used without any defined apertures 50 or suitable slit 51, a sleeve reservoir 20 is useful when such apertures 50 or slits 51 are present. Further, a sleeve 20 without a reservoir area or cavity 31 may be used as described below.

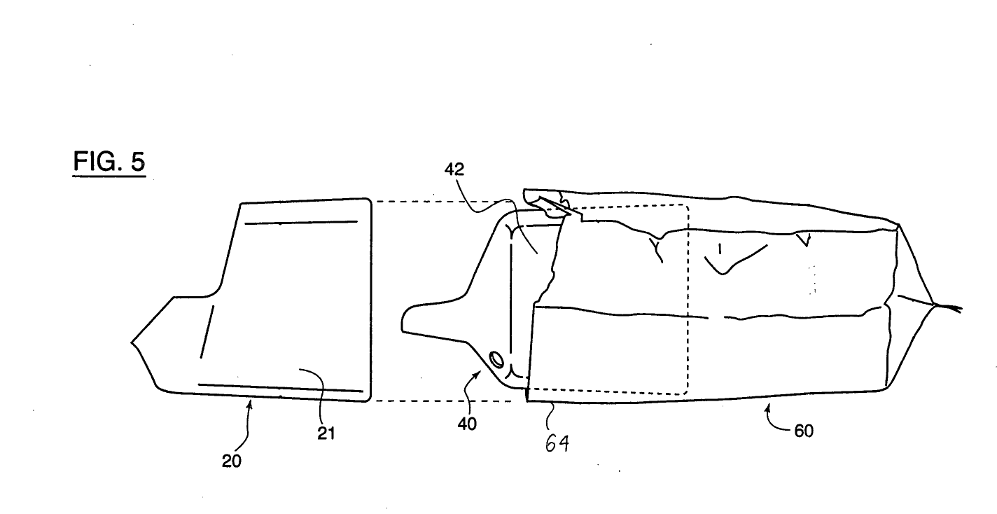

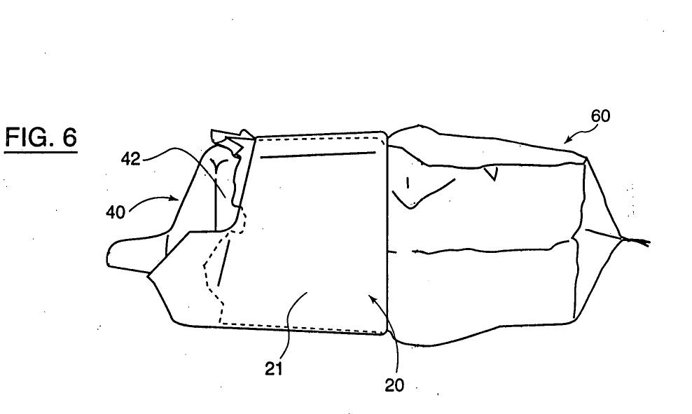

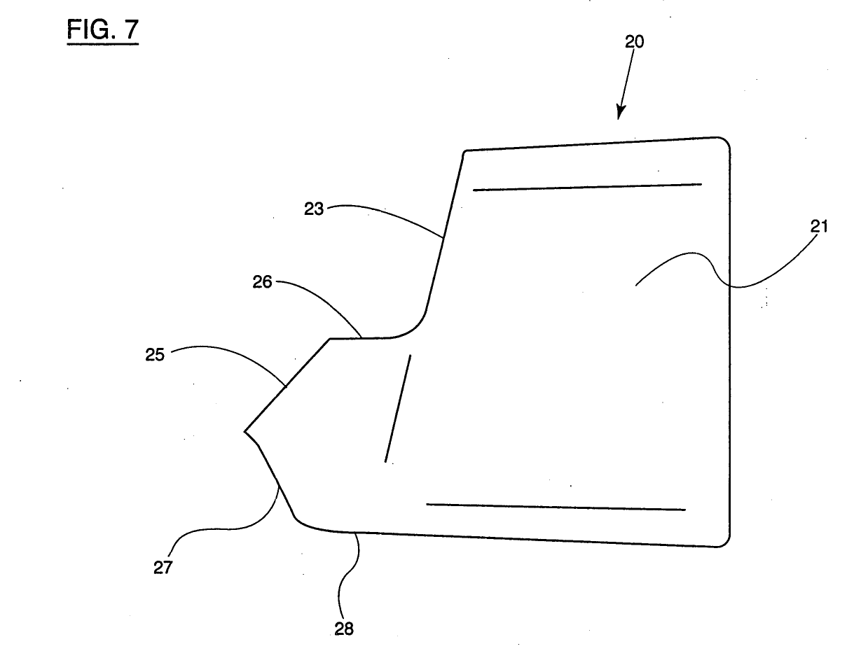

The sleeve reservoir 20 is depicted in FIGS. 7, 11, and 13, and also shown in conjunction with the funnel 40 in FIGS. 1-6 and 9. The sleeve reservoir 20 has the defining characteristic of defining a volume or area between it and the funnel 40, in which unpopped popcorn kernels may be collected.

Referring now specifically to FIG. 11, the sleeve reservoir 20 is defined by an outer sleeve side 21, that has an inner side 22 with a circumference that exceeds slightly the outer circumference of the funnel 40. The sleeve and reservoir 20 has a defined back edge 24 and a front edge 23, with that portion between said edges and 23 and 24 comprising the sleeve portion. The sleeve reservoir 20 also comprises a cavity area 31, comprising a forward extension on the bottom portion of said sleeve 20. While the sleeve portion is fairly close in tolerance to the shape and size of the funnel 40, the sleeve reservoir 20 comprises a front bulged shape that differs from the angled bottom side area of the front surface 41 of the funnel 40, so as to define a cavity 31 in which unpopped kernels may be collected that fall through apertures 50 or a slit 51.

Referring now also specifically to FIG. 13, the sleeve reservoir 20 shows a general side configuration that is virtually identical in size and shape to the funnel 40 in FIG. 12. The primary difference between the outer surface of the funnel 40 and sleeve 20 is that the bottom inner sleeve side 22 extends farther forward, a than does the funnel 40, with the extension forward comprising the cavity bottom side 28. Said bottom side 28 is also depicted specifically in FIG. 7 and FIG. 9.

Referring now specifically to FIG. 8 and FIG. 9, the front side 41 of the funnel 40 is shown with an aperture 50, where said aperture 50 is representative of the type of opening, be it an aperture 50, or a slit 51.

As is seen in FIG. 9, when the sleeve reservoir 20 is slid over the funnel 20, the front-end 27 of the sleeve 20 and the front side 41 of the funnel 40 have an area between them which is referred to as the cavity 31. The cavity 31 comprises a space and sufficient to collect numerous unpopped popcorn kernels which moved through the aperture 50 (or slit 51), and where said unpopped popcorn kernels remain until intentionally removed. One method of removal is to separate the funnel 40 and sleeve reservoir 20 from each other and dump the kernels out, while another method is to simply tilt the assembly upward, so that the spout 45 is oriented upward with the bag 60 directly below the funnel 40, and shake the assembly so that unpopped kernels move back through the apertures 50 or slit 51, and fall back into the bag 60.

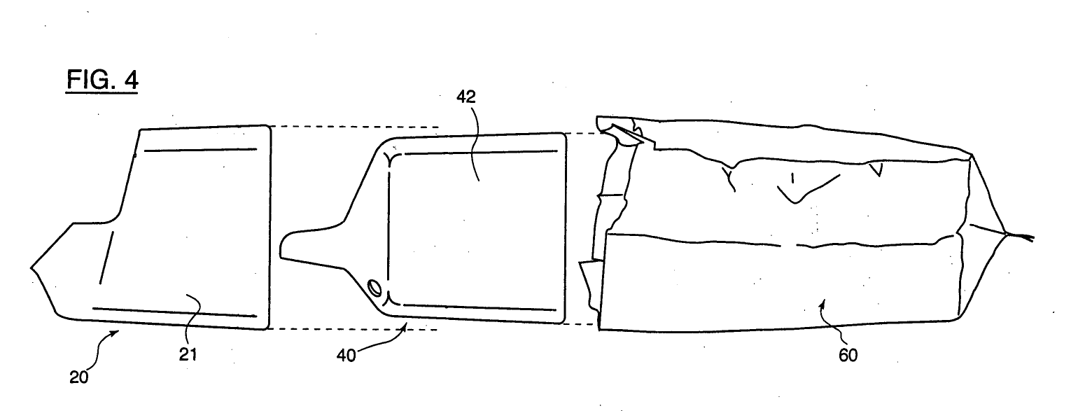

Referring now also to FIG. 20, a funnel 20 having a sleeve 68 is shown, where the sleeve does not define a separate reservoir 31, but simply defines a strap 70, having a length defined by ends 69 and 71. The strap 70 is preferably comprised of a flexible material, having an overall length that exceeds the outer diameter of the funnel 40. The ends 69 and 71 are secured to each other, or with one end secured along the length of the strap, so that the strap 68 effectively encircles the funnel. Connection can be made using any type of attachment means commonly known and understood in the art. The strap 70 operates in the same fashion as the sleeve reservoir 20 does in FIGS. 4-6, in combination with bag 60.

Referring now also to FIG. 21, the strap 70 may be a single loop that is comprised of a flexible and elastic material, whose resting and non stretched diameter is less than the outer diameter of the funnel 40. In this manner, the strap 70 will secure a bag 60 to the funnel 40, in a manner consistent with that shown in FIGS. 4-6. In both FIG. 20 and FIG. 21, there is no reservoir defined which can collect unpopped popcorn kernels, but both provide the means to secure the bag 60 to the funnel 40.

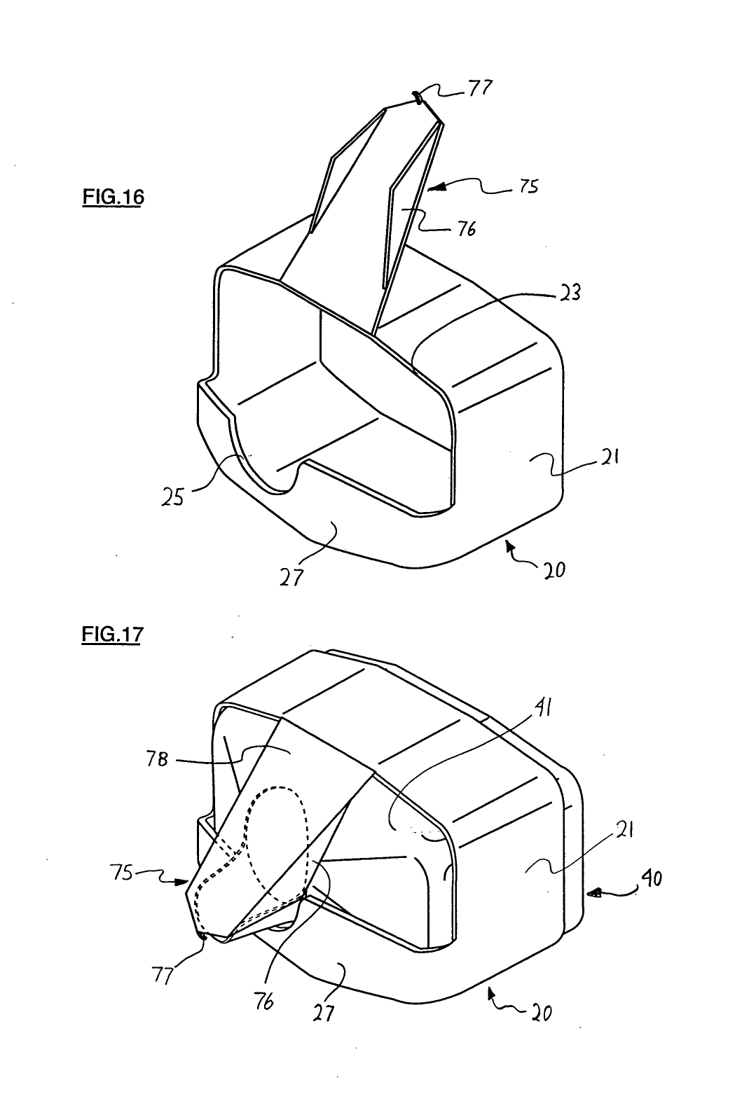

Referring now also to FIG. 16 and 17, the sleeve reservoir 20 is shown, in which a flap 75 is depicted in an open position a FIG. 16, and a closed position in FIG. 17. The flap 75 is pivotally connected to the top front edge 23 of the sleeve reservoir 20, and said flap 75 is capable of closing off access to contents within the funnel 40. As is shown in FIGS. 16 and 17, the flap 75 has downward protruding sides 76, which are shaped so as to conform to the space between the flap body 78 and the funnel 40 and spout 45. A clip 77 may be used to secure the flap 75 against the front edge of the spout 45.

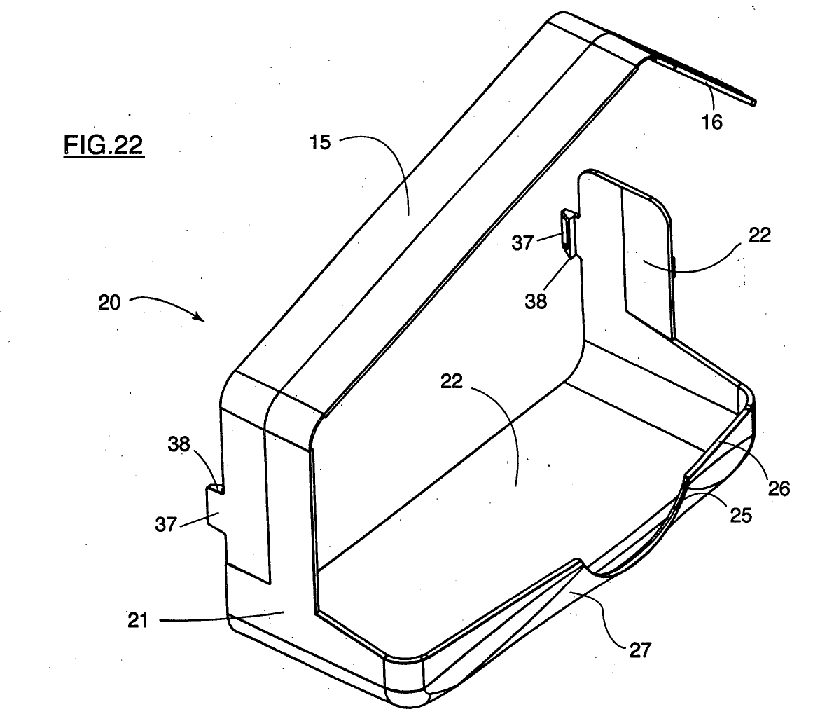

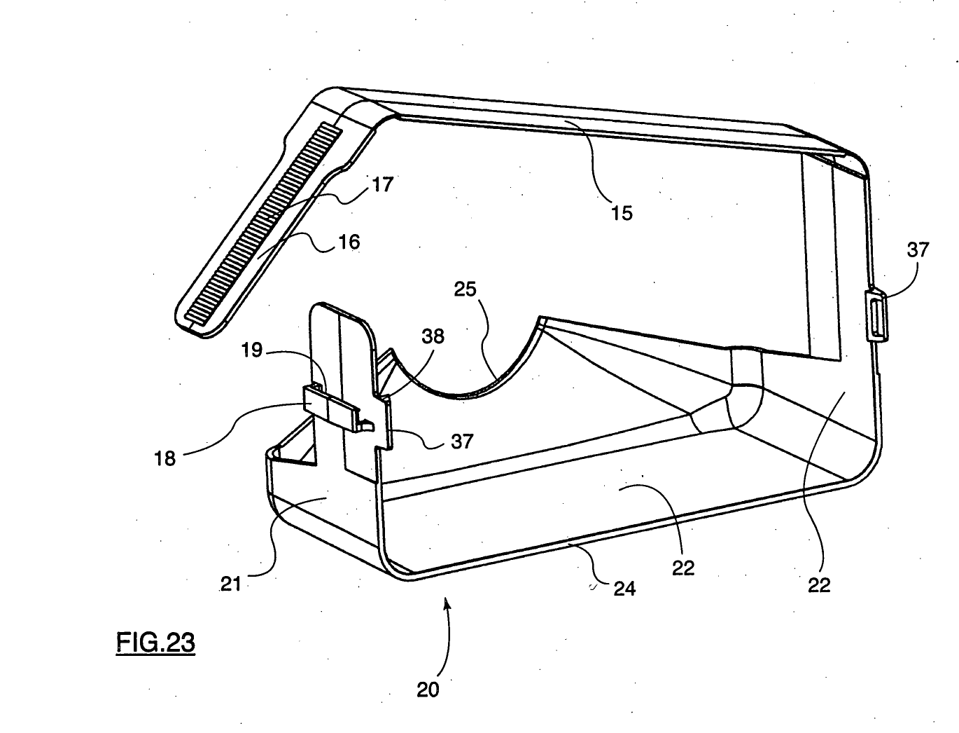

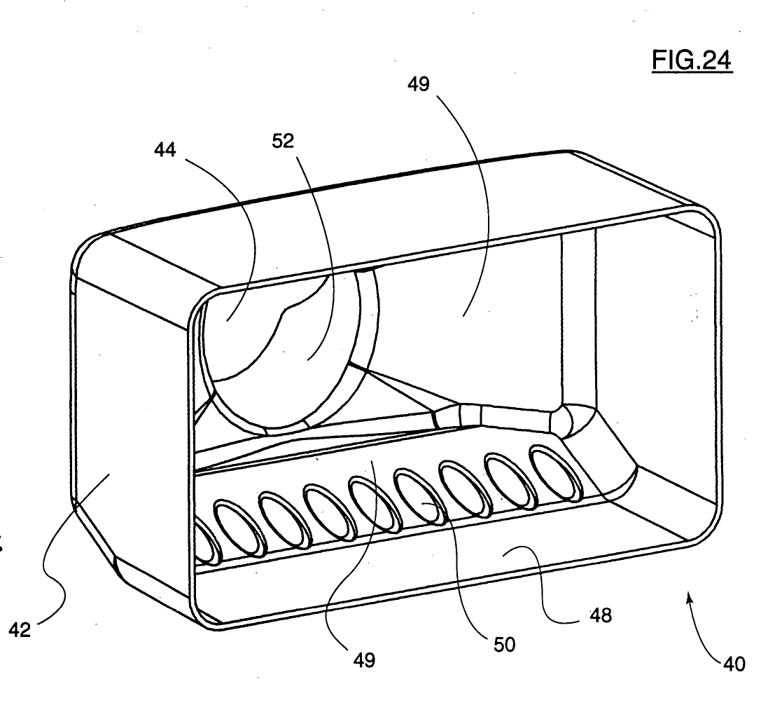

Referring now also to FIGS. 22 and 23, a sleeve reservoir 20 is shown, in which the sleeve portion comprises a movable strap 15, having an end portion 16, which has a surface that defines multiple variations in surface texture. These variations typically comprise grooves or ridges 17. The outer sleeve side 21 defines a loop 18, which encircles a gap 19, located between said loop 18 and the sleeve's outer side 21.

The end portion 16 is placed through gap 19, so that in the grooves or ridges 17 contact the inner surface of the loop 18. Through friction, the end portion 16 will not readily retract out of said loop 18, thereby allowing the circumference of the strap 15 and reservoir body 20 to be adjusted to a particular and desired circumference.

When the reservoir 20, as shown in FIGS. 23 and 23, is adjusted so that it has an interior circumference that slightly exceeds the circumference of a funnel 40, the reservoir 20 is able to be placed over the front portion of said funnel 40, and is secured into position.

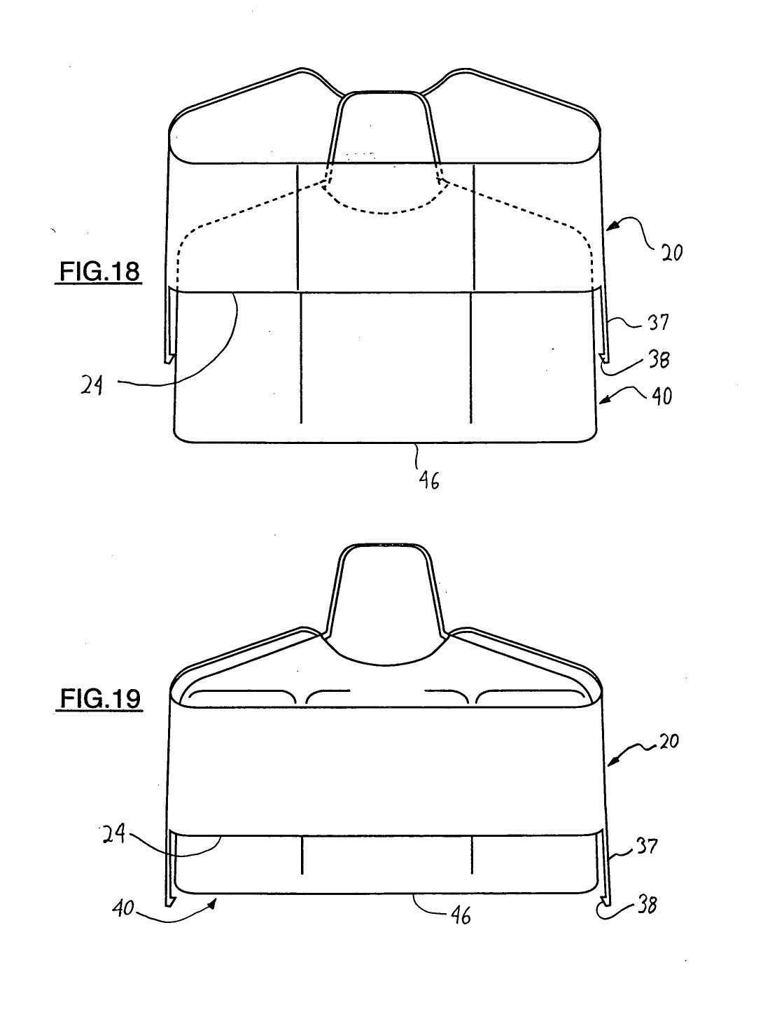

FIGS. 18 and 19, and 22 and 23 show hook means that comprise rear ward extending flanges 37 with angled protrusions 38. Referring now also to FIG. 24 and 25, the reservoir sleeve 20 is slid over the front portion of funnel 40, until said hook means 37 move past the back edge 46, whereby said angled protrusions 38 move directly adjacent to and behind the back edge, and do not permit said reservoir 40 from sliding forward off of the funnel 20 hooks extensions, that protrude.

From the foregoing statements, summary and description in accordance with the present invention, it is understood that the same are not limited thereto, but are susceptible to various changes and modifications as known to those skilled in the art and we therefore do not wish to be limited to the details shown and described herein, but intend to cover all such changes and modifications which would be encompassed by the scope of the appended claims.

1. An apparatus to direct the flow of popcorn from a container directly to a person's mouth, comprising:
a. a funnel means that defines an opening through which popped popcorn is able to exit the popcorn container, where said funnel means has a diameter limited in size so that it is able to be inserted into the mouth of a popcorn container;
b. a sleeve means, which secures the funnel means to a popcorn container.

2. An apparatus to direct the flow of popcorn from a container directly to a person's mouth, as recited in claim 1, in which the funnel means defines a spout around the bottom edge of the funnel means opening.

3. An apparatus to direct the flow of popcorn from a container directly to a person's mouth, as recited in claim 1, in which the funnel means defines one or more apertures, in addition to the opening, which allow unpopped popcorn kernels to pass through them, but which have an insufficient diameter to allow normal popped popcorn from passing through it.

4. An apparatus to direct the flow of popcorn from a container directly to a person's mouth, as recited in claim 1, in which the funnel means defines a slit, which defines a width that allows unpopped popcorn kernels to pass through it, but which have an insufficient width to allow normal popped popcorn from passing through it.

5. An apparatus to direct the flow of popcorn from a container directly to a person's mouth, as recited in claim 1, in which the funnel means comprises an angular configuration, with its back end diameter are being greater than its front end diameter, and where the sides of the funnel means are angled in proportion to the difference in diameter between the front and back end.

6. An apparatus to direct the flow of popcorn from a container directly to a person's mouth, as recited in claim 1, in which the sleeve means comprises an inner side diameter that is greater than the outer diameter of the funnel means.

7. An apparatus to direct the flow of popcorn from a container directly to a person's mouth, as recited in claim 1, in which the sleeve means defines a notch whose edge will fit around a protruding spout defined on the funnel means.

8. An apparatus to direct the flow of popcorn from a container directly to a person's mouth, as recited in claim 1, in which the sleeve means defines a front side cavity, comprising a volume located between the bottom front side of the funnel means, and the bottom front side of the sleeve means.

9. An apparatus to direct the flow of popcorn from a container directly to a person's mouth, as recited in claim 1, in which the sleeve means defines a flap.

10. An apparatus to direct the flow of popcorn from a container directly to a person's mouth, as recited in claim 1, in which the sleeve means comprises a strap that is able to encircle the funnel means, and where said strap ends are able to be joined together.

11. An apparatus to direct the flow of popcorn from a container directly to a person's mouth, as recited in claim 1, in which the sleeve means comprises a flexible strap that is able to encircle the funnel means.

12. An apparatus to direct the flow of popcorn from a container directly to a person's mouth, as recited in claim 1, in which the sleeve means comprises an elastic strap that is able to encircle the funnel means, with the resting diameter of the elastic strap being less than the outer diameter of the funnel means.

13. An apparatus to direct the flow of popcorn from a container directly to a person's mouth, as recited in claim 1, in which the sleeve means it is secured in position to the funnel means, through one or more hooks, which have protrusions that are placed behind the funnel means, and which restrict forward movement of the sleeve means away from the funnel means.

14. An apparatus to direct the flow of popcorn from a container directly to a person's mouth, as recited in claim 1, in which the funnel means is able to be inserted into the mouth of a popcorn container, so that the side edges of the popcorn container are adjacent to the outer sides of the funnel means, and where the sleeve means is placed around the funnel means, with the ends of the popcorn container disposed between the funnel means and the sleeve means.

15. A novel method for creating an integrated popcorn container and apparatus to direct the flow of popcorn from a container directly to a person's mouth end cap means, comprising the steps of:
a. Inserting a funnel means into the mouth opening of the popcorn container, where the funnel means has an opening through which popcorn is able to move through, so that the sides of the popcorn container surrounds the outer sides of said funnel means;
b. Placing a sleeve means around the funnel means and container sides, and securing said sleeve means to said funnel means, with the container sides situated therein between the funnel and sleeve means.

16. A novel method for creating an integrated popcorn container and end cap means, as recited in claim 15, comprising the additional step of securing the sleeve means to the funnel means, with the container sides situated between the funnel and sleeve means, by hooking the sleeve means to the funnel means.

17. An apparatus to direct the flow of popcorn from a container directly to a person's mouth, to direct the flow of popcorn from the container directly to a person's mouth, comprising:
a. a funnel means that defines an opening through which popped popcorn is able to exit the popcorn container, where said funnel means has a diameter limited in size so that it is able to be inserted into the mouth of a microwave popcorn bag;
b. a sleeve means, which is able to be slid over the funnel, where the sleeve means is adjustable as to overall circumference, and which is secured to the funnel though a hook means that contact the rear side of the funnel, where the popcorn container sides are placed between the funnel and sleeve means.

18. An apparatus to direct the flow of popcorn from a container directly to a person's mouth, as recited in claim 17, in which the sleeve means comprises an adjustable strap, having an end means that defines a surface that allows it to be secured within a loop, defined on the side of the sleeve.
